(19) United States
(12) Patent Application Publication
(10) Pub. No.: US 2025/0181180 A1
(43) Pub. Date: Jun. 5, 2025

(54) METHOD FOR TEXT INPUT USING DIGIT OF HUMAN HAND

(71) Applicant: MING-YING WU, New Taipei City (TW)

(72) Inventor: MING-YING WU, New Taipei City (TW)

(21) Appl. No.: 18/525,838

(22) Filed: Nov. 30, 2023

(51) Int. Cl. G06F 3/041; G06F 3/04886

(52) U.S. Cl. CPC G06F 3/041; G06F 3/04886; G06F 2203/04108

(57) ABSTRACT

A method for text input using a preset digit of a human hand includes steps of sensing a primary feature of the preset digit of the human hand, sensing a secondary feature of the preset digit of the human hand, combining the sensed primary feature with the sensed secondary feature to create an input unit, associating characters to be input with primary features to be sensed and secondary features to be sensed, comparing the input unit with the primary features to be sensed and the secondary features to be sensed associated with the characters to be input to retrieve a character intended to be input corresponding to the input unit, and repeating the sensing primary feature step, the sensing secondary feature step, the combining step and the comparing step until a text to be input is completely input.

### BACKGROUND OF THE INVENTION

### Field of the Invention

The present invention relates to a method for text input using at least a digit of a human hand. Particularly, a method for text input includes sensing at least one digit movement of the at least a digit of the human hand in order to achieve text input on a display via processing of a processor.

### Description of Related Art

Traditionally, texts are usually input via keyboards equipped within electronic devices. The keyboards are either physically disposed on the electronic devices, and/or virtually displayed on screens of the electronic devices. When a text intended to be input is about to be input, a user has to choose corresponding keys from the keyboards in order to input the text intended to be input in the electronic devices. In other words, the user has to be familiar with a layout of the keyboards which is usually fixed after manufacture of the electronic devices in order to efficiently input the text intended to be input. Hence, the user must firstly find out the corresponding keys from the keyboards and then move his/her fingers toward locations of the corresponding keys to press the corresponding keys based on an order decided by the text intended to be input. Apparently, not only the user had better memorize locations of all keys on the layout of the keyboards, but also his/her fingers have to be moved toward the corresponding keys to press them for text input. Therefore, it is very common for the user to adopt both of his/her hands and fingers with both hands to be ready for the entire layout of the keyboards in order to speed up the text input when the user is about to input the text intended to be input. Text input using a single hand, particularly using a digit of the single hand, of the user is well known to be more time-consuming than using two hands with multiple digits of the user.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic flowchart diagram of a method for text input using at least a digit of a human hand in accordance with a preferred embodiment of the present invention.

FIG. 2 shows a schematic side view of a preferred digit of a human hand presenting an original primary feature and other preset primary features of the preferred digit of the human hand for the method for text input using at least a digit of a human hand of FIG. 1 in accordance with a preferred embodiment of the present invention.

FIG. 3 shows a schematic side view of the preferred digit of the human hand presenting an original secondary feature and other preset secondary features of the preferred digit of the human hand for the method for text input using at least a digit of a human hand of FIG. 1 in accordance with a preferred embodiment of the present invention.

FIG. 4 shows a schematic perspective view of a virtual character assigning feature table corresponding to the preferred digit of the human hand presenting the original primary feature and the original secondary feature, and presenting the other preset primary features and the other secondary features of the preferred digit of the human hand for the method for text input using at least a digit of a human hand of FIG. 1 in accordance with a preferred embodiment of the present invention.

FIGS. 5a to 5e respectively show schematic side views of the preferred digit of the human hand presenting the original primary feature and each of the other preset primary features of the preferred digit of the human hand, and further presenting either of the original primary feature and the each of the other preset primary features of the preferred digit of the human hand together with presenting the original secondary feature and the other preset secondary features of the preferred digit of the human hand corresponding to assigned English characters for the method for text input using at least a digit of a human hand of FIG. 1 in accordance with a preferred embodiment of the present invention.

FIGS. 6a to 6e respectively show schematic side views of the preferred digit of the human hand presenting the original primary feature and the each of the other preset primary features of the preferred digit of the human hand, and further presenting either of the original primary feature and the each of the other preset primary features of the preferred digit of the human hand together with presenting the original secondary feature and the other preset secondary features of the preferred digit of the human hand corresponding to assigned Chinese phonetic characters for the method for text input using at least a digit of a human hand of FIG. 1 in accordance with a preferred embodiment of the present invention.

FIGS. 7a to 7e, 8a to 8e and 9 respectively show schematic side views of three preferred digits of the human hand presenting the original primary feature and the each of the other preset primary features of the preferred digit of the human hand, and further presenting either of the original primary feature and the each of the other preset primary features of the three preferred digits of the human hand together with presenting the original secondary feature and the other preset secondary features of the three preferred digits of the human hand corresponding to assigned Chinese phonetic characters for the method for text input using at least a digit of a human hand of FIG. 1 in accordance with a preferred embodiment of the present invention.

### DETAILED DESCRIPTION OF THE INVENTION

In order to facilitate best understanding of the present invention, the present invention will be illustrated in more detail below in conjunction with the attached drawings and preferred embodiments. It should be noted that when an element is expressed as “being fixed to” another element, this element may be directly on the another element, or there may be one or more intervening elements between this element and the another element. When an element is expressed as “being connected to” another element, this element can be directly connected to the another element, or there may be one or more intervening elements between this element and the another element. In addition, terminology such as “first”, “second”, etc., is only used for descriptive purposes, and cannot be understood as indicating or implying relative importance.

Unless otherwise defined, any technical and scientific terminology used in this specification has the same meaning as commonly understood by those skilled in the technical field of the present invention. Terminology used in this specification of the present invention is only for a purpose of describing specific embodiments, and is not used to limit the present invention. Terminology such as “and/or” used in this specification includes any and all combinations of one or more related listed items.

In addition, technical features involved in different embodiments of the present invention described below can be mutually combined as long as they do not conflict with one another.

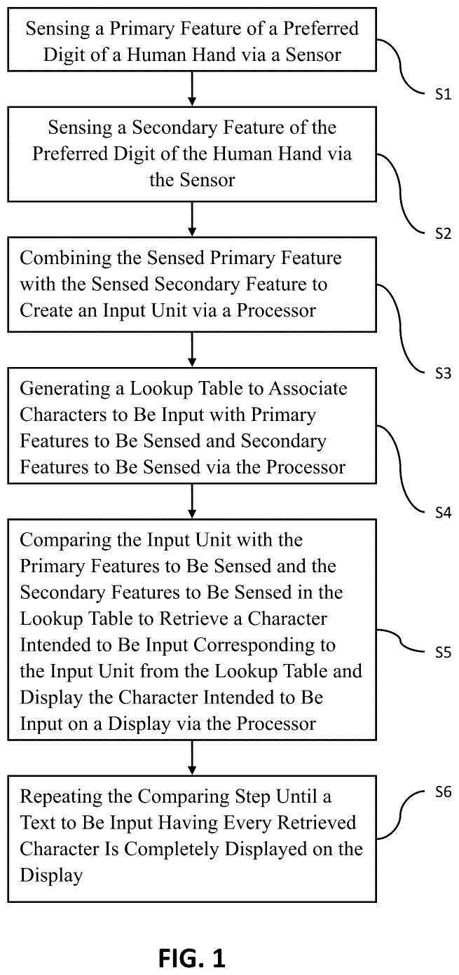

Referring to FIG. 1, a method for text input using at least a digit of a human hand in accordance with a preferred embodiment of the present invention includes the following steps.

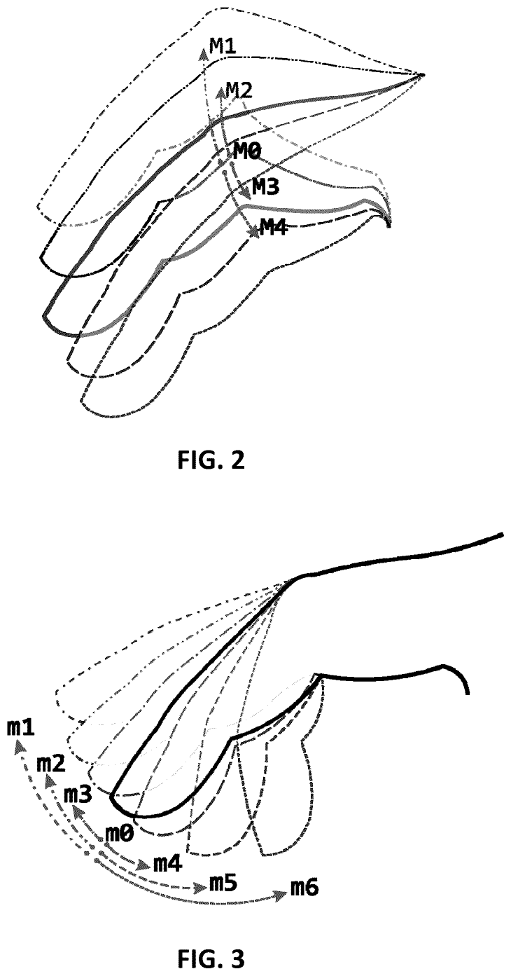

A first step S1 is provided for sensing a primary feature (i.e., primary features M0 to M4 as shown in FIG. 2) of a preferred digit of a human hand via a sensor. The preferred digit of the human hand may be either one of a thumb, an index finger, a middle finger, a ring finger and a little finger. The primary feature M0 in FIG. 2 is defined as an original primary feature of the preferred digit of the human hand. The primary feature M1 in FIG. 2 is defined as a first moving feature of the preferred digit of the human hand away from the original primary feature M0. In the preferred embodiment of the present invention as shown in FIG. 2, the first primary feature M1 is a primary feature of the preferred digit of the human hand moving upwards away from the original primary feature M0. Alternatively, the first primary feature M1 can be a primary feature of the preferred digit of the human hand moving downwards away from the original primary feature M0. In a preferred embodiment of the present invention as shown in FIG. 2, the first primary feature M1 is a primary feature of the preferred digit of the human hand moving away from the original primary feature M0 along a first direction (i.e., an upward direction as shown in FIG. 2) for a first distance. In the preferred embodiment of the present invention, the first distance is defined as a longest distance the preferred digit of the human hand can be moved upwards in FIG. 2 under a preferred comfortable condition of the preferred digit of the human hand. The primary feature M2 in FIG. 2 is defined as a second moving feature of the preferred digit of the human hand away from the original primary feature M0. In the preferred embodiment of the present invention as shown in FIG. 2, the second primary feature M2 is defined as a primary feature of the preferred digit of the human hand moving away from the original primary feature M0 along the first direction for a second distance. Preferably, the second distance is a half of the first distance. The primary feature M3 in FIG. 2 is defined as a third moving feature of the preferred digit of the human hand away from the original primary feature M0 along a second direction. Preferably, the second direction is a direction opposite to the first direction (i.e., a downward direction as shown in FIG. 2). In the preferred embodiment of the present invention as shown in FIG. 2, the third primary feature M3 is defined as a primary feature of the preferred digit of the human hand moving away from the original primary feature M0 along the second direction for a third distance. The primary feature M4 in FIG. 2 is defined as a fourth moving feature of the preferred digit of the human hand away from the original primary feature M0 along the second direction. In the preferred embodiment of the present invention as shown in FIG. 2, the fourth primary feature M4 is defined as a primary feature of the preferred digit of the human hand moving away from the original primary feature M0 along the second direction for a fourth distance. Preferably, the fourth distance is defined as a longest distance the preferred digit of the human hand can be moved downwards in FIG. 2 under a preferred comfortable condition of the preferred digit of the human hand. In the preferred embodiment of the present invention as show in FIG. 2, the fourth distance is twice of the third distance.

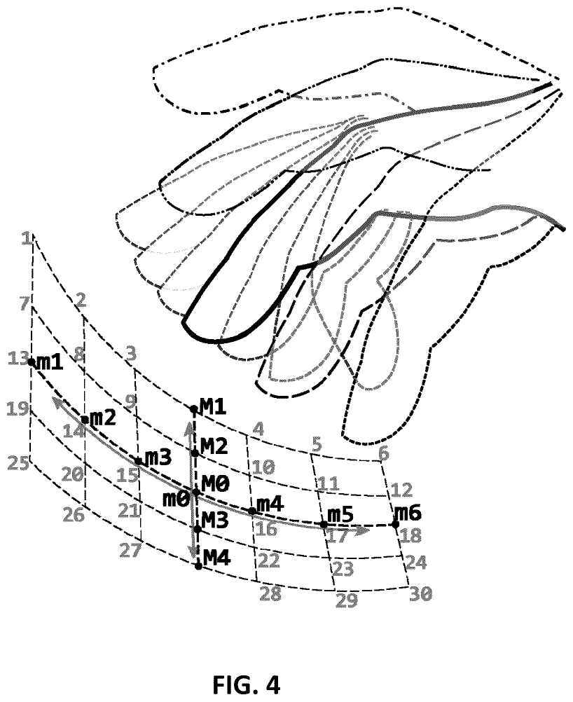

A second step S2 is provided for sensing a secondary feature (i.e., secondary features m0 to m6 as shown in FIG. 3) of the preferred digit of the human hand via the sensor. The secondary features are defined as features of at least a distal phalange of the preferred digit of the human hand. In the case of the preferred digit of the human hand being a thumb, the secondary features are defined as distal features of a distal phalange of the thumb. In the case of the preferred digit of the human hand being a digit of the human hand other than the thumb, the secondary features are defined as distal features of a distal phalange and an intermediate phalange of the digit of the human hand other than the thumb. The secondary feature m0 in FIG. 3 is defined as an original secondary feature of the preferred digit of the human hand. The secondary feature m1 in FIG. 3 is defined as a first moving secondary feature of the preferred digit of the human hand away from the original secondary feature m0. In the preferred embodiment of the present invention as shown in FIG. 3, the first secondary feature m1 is a secondary feature of the preferred digit of the human hand moving away from the original secondary feature m0 along the first direction (i.e., the upward direction as shown in FIG. 3) for a fifth distance. In the preferred embodiment of the present invention, the fifth distance is defined as a longest distance a distal phalange of the preferred digit of the human hand can be moved upwards in FIG. 3 under the preferred comfortable condition of the preferred digit of the human hand. The secondary feature m2 in FIG. 3 is defined as a second moving secondary feature of the preferred digit of the human hand away from the original secondary feature m0. In the preferred embodiment of the present invention as shown in FIG. 3, the second secondary feature m2 is a secondary feature of the preferred digit of the human hand moving away from the original secondary feature m0 along the first direction for a sixth distance. The secondary feature m3 in FIG. 3 is defined as a third moving secondary feature of the preferred digit of the human hand away from the original secondary feature m0. In the preferred embodiment of the present invention as shown in FIG. 3, the third secondary feature m3 is a secondary feature of the preferred digit of the human hand moving away from the original secondary feature m0 along the first direction for a seventh distance. In the preferred embodiment of the present invention as show in FIG. 3, the sixth distance is twice of the seventh distance, and the fifth distance is triple of the seventh distance. The secondary feature m4 in FIG. 3 is defined as a fourth moving secondary feature of the preferred digit of the human hand away from the original secondary feature m0. In the preferred embodiment of the present invention as shown in FIG. 3, the fourth secondary feature m4 is a secondary feature of the preferred digit of the human hand moving away from the original secondary feature m0 along the second direction (i.e., the downward direction as shown in FIG. 3) for an eighth distance. The secondary feature m5 in FIG. 3 is defined as a fifth moving secondary feature of the preferred digit of the human hand away from the original secondary feature m0. In the preferred embodiment of the present invention as shown in FIG. 3, the fifth secondary feature m5 is a secondary feature of the preferred digit of the human hand moving away from the original secondary feature m0 along the second direction for a ninth distance. The secondary feature m6 in FIG. 3 is defined as a sixth moving secondary feature of the preferred digit of the human hand away from the original secondary feature m. In the preferred embodiment of the present invention as shown in FIG. 3, the sixth secondary feature m6 is a secondary feature of the preferred digit of the human hand moving away from the original secondary feature m0 along the second direction for a tenth distance. Preferably, the tenth distance is defined as a longest distance the distal phalange of the preferred digit of the human hand can be moved downwards in FIG. 3 under a preferred comfortable condition of the preferred digit of the human hand. In the preferred embodiment of the present invention as show in FIG. 3, the ninth distance is twice of the eighth distance, and the tenth distance is triple of the eighth distance.

Alternatively, the first step S1 can be performed after the second step S2 or the first step S1 and the second step S2 can be performed simultaneously. In the preferred embodiment of the present invention as shown in FIG. 1, the preferred digit of the human hand is used to perform both of the first step S1 and the second step S2 sequentially. Alternatively, the preferred digit of the human hand can be used to only perform a selective one of the first step S1 and the second step S2 while another preferred digit of the human hand is used to perform the other one of the first step S1 and the second step S2. Of course, in the case that both of the preferred digit of the human hand and the another preferred digit of the human hand are used, the first step S1 and the second step S2 can be performed sequentially or simultaneously.

A third step S3 is provided for combining the sensed primary feature with the sensed secondary feature to create an input unit via a processor signally communicated with the sensor. The input unit can be in form of a matrix, or other proper forms to record the sensed primary feature and the sensed secondary feature. In the preferred embodiment of the present invention as shown in FIG. 2, the sensed primary feature is recorded as a sensed one of “M0, . . . , M4” which respectively represent the original and first to fourth primary features as shown in FIG. 2. In the preferred embodiment of the present invention as shown in FIG. 3, the sensed secondary feature is recorded as a sensed one of “m0, . . . , m6” which respectively represent the original and first to sixth secondary features as shown in FIG. 3. For instance, in the preferred embodiment of the present invention as shown in FIG. 2 and FIG. 3, the input unit is combined and recorded as “[M2, m3]” when the preferred digit of the human hand is sensed to sequentially move to the second primary feature M2 in the first step S1 and move to the third secondary feature m3 in the second step S2.

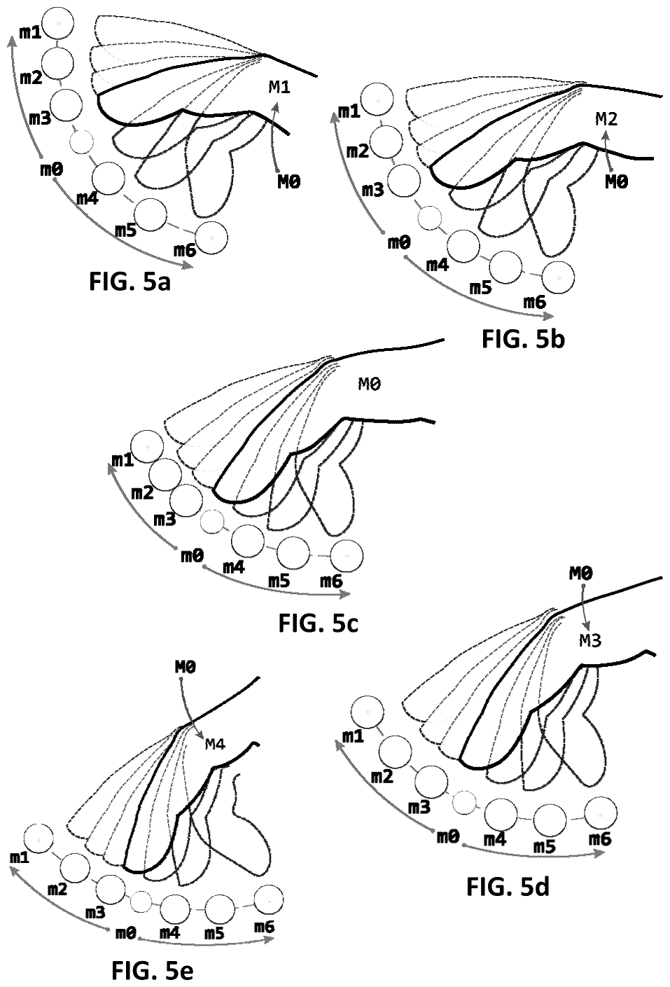

A fourth step S4 is provided for generating a lookup table (i.e., a virtual character assigning feature table containing character assigning features 1-30 as shown in FIG. 4) to associate characters to be input with primary features to be sensed and secondary features to be sensed via the processor. The generated lookup table is configurated to be saved in a memory signally communicated with the processor. In the preferred embodiment of the present invention as shown in FIG. 4, the lookup table is configurated to expand by using the primary features to be sensed (i.e., the primary features M0 to M4 as shown in FIG. 2) as vertical coordinates and the secondary features to be sensed (i.e., the secondary features m0 to m6 as shown in FIG. 3) as horizontal coordinates. In the preferred embodiment of the present invention as shown in FIG. 4, the lookup table is a 5 by 6 matrix with the character assigning features 1-30 as shown in FIG. 4. Taking text input in English as an example, either one of English characters A-Z can be respectively exclusively assigned to a selective one of the character assigning features 1-30 as shown in FIG. 4.

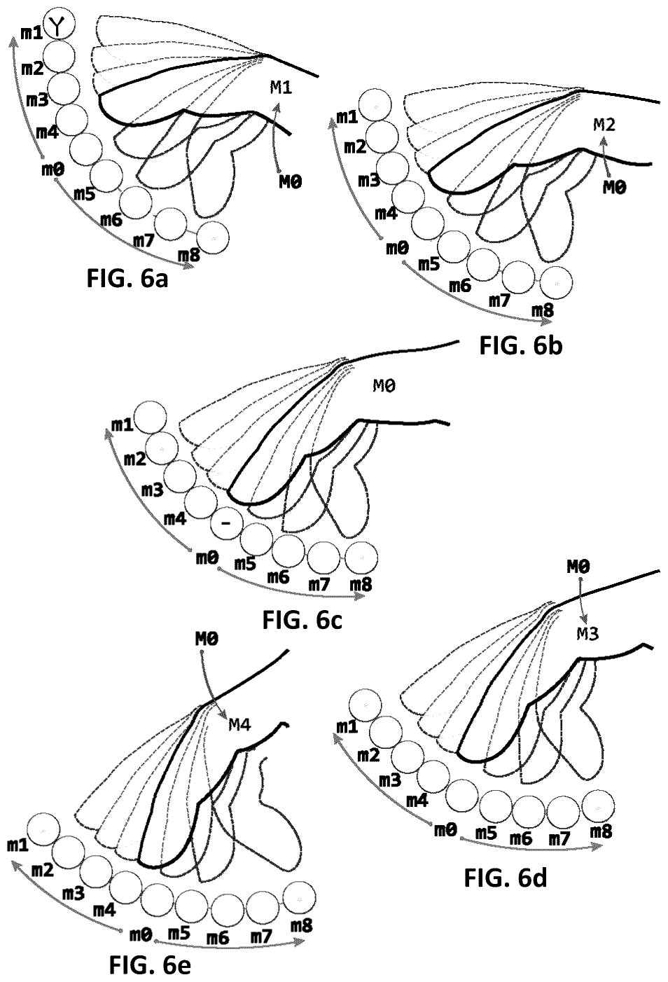

Further referring to FIG. 4 and FIGS. 5a to 5e together, the character assigning features 1-6 of the lookup table as shown in FIG. 4 are respectively used and assigned for English characters “a”, “e”, “1”, “n”, “r” and “q” as shown in FIG. 5a. The character assigning features 7-12 of the lookup table as shown in FIG. 4 are respectively used and assigned for English characters “c”, “z”, “v”, “b”, “d” and “g” as shown in FIG. 5b. The character assigning features 13-18 of the lookup table as shown in FIG. 4 are respectively used and assigned for English characters “h”, “s”, “f”, “p”, “t” and “k” as shown in FIG. 5c. The character assigning features 20-23 of the lookup table as shown in FIG. 4 are respectively used and assigned for English characters “j”, “y”, “x” and “w” as shown in FIG. 5d while the character assigning features 19 and 24 of the lookup table as shown in FIG. 4 are left to be unassigned. The character assigning features 25, 27 and 29-30 of the lookup table as shown in FIG. 4 are respectively used and assigned for English characters “i”, “m”, “o” and “u” as shown in FIG. 5e while the character assigning features 26 and 28 of the lookup table as shown in FIG. 4 are left to be unassigned. Of course, the English characters can be assigned in other ways different from the assigning way as shown in FIGS. 5a to 5e as long as all of English characters are respectively and exclusively assigned to corresponding character assigning features selected from the character assigning features 1-30 of the lookup table as shown in FIG. 4.

Alternatively, the fourth step S4 can be performed before the first step S1 or the fourth step S4 and the first step S1 to the third step S3 can be performed simultaneously. In the preferred embodiment of the present invention as shown in FIG. 1, the fourth step S4 is performed after the third step S3 so as to provide a comparative source together with the third step before following steps of the present invention.

A fifth step S5 is provided for comparing the input unit with the primary features to be sensed and the secondary features to be sensed in the lookup table to retrieve a character intended to be input corresponding to the input unit from the lookup table and display the character intended to be input on a display via the processor. The display is signally communicated with the processor so that the processor can control display contents of the display. Referring to FIGS. 5a to 5e, taking text input in English as an example, English characters A-Z are respectively assigned in the lookup table as shown in FIGS. 5a to 5e. The English characters are preferably assigned in the lookup table based on preset conditions, for example, frequent use of particular English characters, comfortable movement of the preferred digit of the human hand, etc. Using the lookup table as showing in FIGS. 5a to 5e, when a text to be input, “text” as an example, is intended to be input, a first input unit of “[M0, m5]” for the text to be input is combined to be created by the processor in the third step S3 after the original primary feature “M0” is sensed by the sensor in the first step S1 and the fifth secondary feature “m5” is sensed by the sensor in the second step S2. The first input unit of “[M0, m5]” for the text to be input is subsequently used to be compared in the fifth step S5 with the lookup table generated in the fourth step S4 in order to retrieve the first English character “t” of the text to be input, “text”, and display the retrieved first English character “t” on the display since, according to the lookup table as shown in FIG. 4 and FIG. 5c, the character assigning feature 17 of the lookup table as shown in FIG. 4 is assigned to the English character “t” as shown in FIG. 5c corresponding to the first input unit of “[M0, m5]”.

A sixth step S6 is provided for repeating the first step S1, the second step S2, the third step S3 and the fifth step S5, i.e., the sensing primary feature step, the sensing secondary feature step, the combining step and the comparing step as shown in FIG. 1, until a text to be input having every retrieved character is completely displayed on the display. As stated above and taking the above text, “text”, intended to be input as an example, after the first English character “t” is displayed on the display by performing the first step S1, the second step S2, the third step S3 and the fifth step S5 in sequence, the second English character “e” of the text to be input, “text”, is retrieved and displayed on the display in a repeated fifth step S5 after the first primary feature “M1” and the second secondary feature “m2” are respectively sensed in repeated first and second steps S1, S2, and a second input unit of “[M1, m2]” is combined to be created in a repeated third step S3. The first step S1, the second step S2, the third step S3 and the fifth step S5 are subsequently repeated for two more times in order to respectively retrieve and display the rest English characters, “x” and “t”, of the text to be input, “text”. The sixth step S6 is completed when all English characters, “t”, “e”, “x” and “t”, of the text to be input, “text”, are entirely displayed on the display. The method for text input using at least a digit of a human hand in accordance with the preferred embodiment of the present invention will be started over again when a next text to be input is ready to be input.

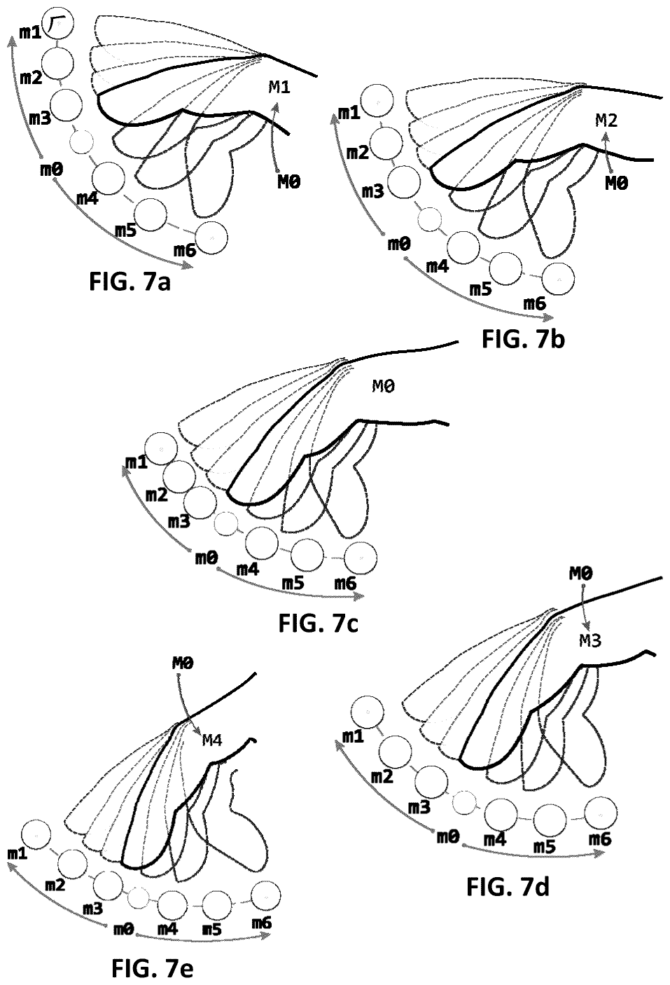

Referring to FIGS. 6a to 6e, a lookup table for a Chinese text to be input by using a single digit of the human hand in accordance with a preferred embodiment of the present invention is shown. As shown in FIGS. 6a to 6e, the lookup table is a 5 by 9 matrix with 45 character assigning features as shown in FIGS. 6a to 6e as a whole. 37 phonetic characters and 5 tone marks required for inputting a Chinese word included in the Chinese text to be input are respectively and exclusively assigned to selective ones of the 45 character assigning features as shown in FIGS. 6a to 6e. Taking the Chinese word “ [symbol] ” as an example, phonetic characters “ [symbol] ”, “ [symbol] ”, “ [symbol] ” and a first tone mark “-” are required to be input in order for displaying the Chinese word “ [symbol] ” on the display. Hence, at least a first input unit “[M2, m1]” for the phonetic character “ [symbol] ”, a second input unit “[M4, m6]” for the phonetic character “ [symbol] ”, and a third input unit “[M4, m4]” for the phonetic character “ [symbol] ” are respectively retrieved and temporarily displayed on the display, and a fourth input unit “[M0, m0]” for the first tone mark is retrieved only to further trigger display of the Chinese word “ [symbol] ” on the display by performing the sixth step S6 repeatedly for at least four times. After the required first tone mark is retrieved, the Chinese word “+” corresponding to the phonetic characters “ [symbol] ”, “ [symbol] ”, “ [symbol] ” and the first tone mark is automatically generated and displayed on the display via the processor while the temporarily displayed phonetic characters “ [symbol] ”, “ [symbol] ”, “L” are removed from the display via the processor.

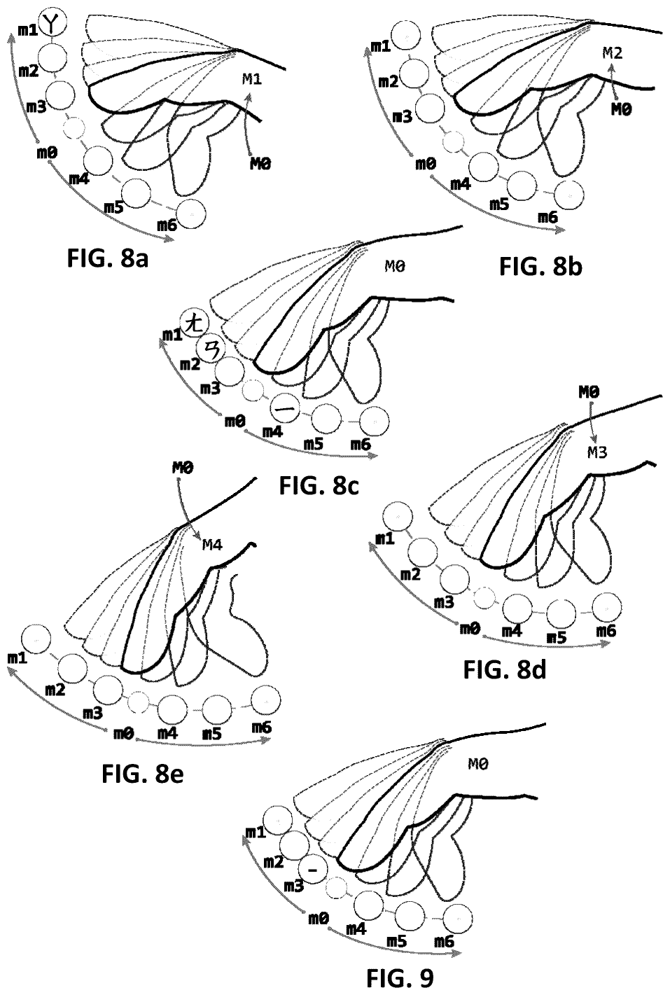

Referring to FIGS. 7a to 7e, 8a to 8e and 9, three lookup tables for a Chinese text to be input by respectively using three different preferred digits of the human hand in accordance with a preferred embodiment of the present invention are shown. FIGS. 7a to 7e show the original primary feature M0 and the first to fourth primary features M1 to M4, and the original secondary feature m0 and the first to sixth secondary features m1 to m6 of a first preferred digit of the human hand, and associated Chinese phonetic characters in accordance with a preferred embodiment of the present invention. FIGS. 8a to 8e show the original primary feature M0 and the first to fourth primary features M1 to M4, and the original secondary feature m0 and the first to sixth secondary features m1 to m6 of a second preferred digit of the human hand, and associated Chinese phonetic characters in accordance with a preferred embodiment of the present invention. FIG. 9 shows the original primary feature M0 and the original secondary feature m0 and the first to sixth secondary features m1 to m6 of a third preferred digit of the human hand, and associated tone marks in accordance with a preferred embodiment of the present invention. In the preferred embodiment of the present invention, the Chinese text to be input is input by using the three different preferred digits of the human hand simultaneously or sequentially, and movements of all of the three different preferred digits of the human hand are respectively sensed by the sensor to generate at least three input units in order to input the Chinese text to be input. Taking the Chinese word “ [symbol] ” as an example again, the phonetic character “ [symbol] ” as shown in FIG. 7b is displayed on the display by sensing movement of the first preferred digit of the human hand and being retrieved from the lookup table as shown in FIGS. 7a to 7e based on the combined input unit “M2, m6”. The phonetic characters “ [symbol] ”, “ [symbol] ” respectively as shown in FIGS. 8d and 8a are sequentially displayed on the display by sensing movements of the second preferred digit of the human hand and being retrieved from the lookup table as shown in FIGS. 8a to 8e based on the combined input units “M3, m4” and “M1, m4” sequentially. The first tone mark “−” as shown in FIG. 9 is retrieved from the lookup table as shown in FIG. 9 based on the combined input unit “M0, m3” after sensing movement of the third preferred digit of the human hand and then further triggering display of the Chinese word “ [symbol] ” on the display.

Although only the preferred embodiments of the present invention are described as above, the practicing claim scope of the present invention is not limited to the disclosed embodiments. It is understood that any simple equivalent changes, adjustments or modifications to the present invention based on the following claims of the present invention and the content of the above invention description may be still covered within the claimed scope of the following claims of the present invention.

1-5. (canceled)

6. (canceled)

7-9. (canceled)

10. (canceled)

11-14. (canceled)

15. (canceled)

16: A method for text input using a preset digit of a human hand, comprising:
defining an original primary feature and an original secondary feature of the preset digit of the human hand;
sensing a primary feature based on a movement of a first part of the preset digit of the human hand moving away from the original primary feature via a sensor;
sensing a secondary feature based on a movement of a second part of the preset digit of the human hand, different from the first part, moving away from the original secondary feature via the sensor;
combining the sensed primary feature with the sensed secondary feature to create an input unit via a processor signally communicated with the sensor;
associating characters to be input with primary features to be sensed including the original primary feature and the secondary features to be sensed including the original secondary feature via the processor;
comparing the input unit with the primary features to be sensed and the secondary features to be sensed associated with the characters to be input to retrieve a character intended to be input corresponding to the input unit from the associated characters to be input via the processor; and
repeating the sensing primary feature step, the sensing secondary feature step, the combining step and the comparing step until a text to be input having the retrieved character intended to be input is completely input.

17: The method as claimed in claim 16, wherein the associating character step further comprises a step of generating a lookup table to associate the characters to be input with the primary features to be sensed and the secondary features to be sensed for use of lookup in comparison with the input unit.

18: The method as claimed in claim 16, wherein another preset digit of the human hand is used, the text to be input is input via using both of the preset digit and the another preset digit.

19: The method as claimed in claim 16, wherein the primary features to be sensed comprise the original knuckle position and at least two moving primary features, the at least two moving primary features are respectively defined as moving away from the original primary feature along a first direction along a preset moving plane.

20: The method as claimed in claim 19, wherein the at least two moving primary features are respectively defined as moving away from the original primary feature along either the first direction along the moving plane or a second direction along the moving plane opposite to the first direction.

21: The method as claimed in claim 19, wherein the at least two moving primary features are respectively defined as moving away from the original primary feature along the first direction, and each of the at least two moving primary features is spaced equidistantly from a neighboring one of the at least two moving primary features next to the each of the at least two moving primary features or the original primary feature.

22: The method as claimed in claim 16, wherein the fingertip positions to be sensed comprise the original secondary feature and at least two moving secondary features, the at least two moving secondary features are respectively defined as moving away from the original secondary feature along a first direction along a moving plane.

23: The method as claimed in claim 22, wherein the at least two moving secondary features are respectively defined as moving away from the original secondary feature along either the first direction along the moving plane or a second direction along the moving plane opposite to the first direction.

24: The method as claimed in claim 22, wherein the at least two moving secondary features are respectively defined as moving away from the original secondary feature along the first direction, and each of the at least two moving secondary features is spaced equidistantly from a neighboring one of the at least two moving secondary features next to the each of the at least two moving secondary features or the original secondary feature.

25: The method as claimed in claim 16, wherein the associating step is executed before the sensing primary feature step and the sensing secondary feature step.

26: The method as claimed in claim 16, wherein the sensing primary feature step and the sensing secondary feature step are executed simultaneously.

27: A method for text input using a single preset digit of a human hand, comprising:
defining an original primary feature and an original secondary feature of the single preset digit of the human hand;
defining primary features to be sensed, including the original primary feature, to which a part of the single preset digit of the human hand is used to be moved;
defining secondary features to be sensed, including the original secondary feature, to which another part of the single preset digit of the human hand different from the part of the single preset digit is used to be moved;
sensing a primary feature out of the defined primary features to be sensed moving away from the original primary feature via a sensor;
sensing a secondary feature out of the defined secondary features to be sensed moving away from the original secondary feature via the sensor;
combining the sensed primary feature with the sensed secondary feature to create an input unit via a processor signally communicated with the sensor;
associating characters to be input respectively with the primary features to be sensed and the secondary features to be sensed via the processor; and
comparing the input unit with the primary features to be sensed and the secondary features to be sensed associated with the characters to be input to retrieve a character intended to be input corresponding to the input unit from the associated characters to be input via the processor; and
repeating the sensing primary feature step, the sensing secondary feature step, the combining step and the comparing step until a text to be input having the retrieved character intended to be input is completely input.
